(19) United States
(12) Patent Application Publication
(10) Pub. No.: US 2011/0170194 A1
(43) Pub. Date: Jul. 14, 2011

(54) OPTICAL SHEET AND DISPLAY DEVICE INCLUDING THE SAME

(76) Inventor: Tsuyoshi KASHIWAGI, Tokyo-to (JP)

(21) Appl. No.: 12/976,008

(22) Filed: Dec. 22, 2010

(30) Foreign Application Priority Data
Dec. 25, 2009 (JP) 2009-295047

(51) Int. Cl. G02B 5/02

(52) U.S. Cl. 359/599

(57) ABSTRACT

An optical sheet and a display device including the optical sheet are disclosed. The optical sheet includes a plurality of layers disposed on an observer side relative to an image source and capable of controlling light from the image source and transmitting the light to the observer side. At least one layer of the plurality of layers is an optical functional layer which includes: light transmissive portions having a trapezoidal cross section and arranged in parallel along a sheet face to be capable of transmitting the light; and light absorbing portions having a wedge-shaped cross section and arranged in parallel between the light transmissive portions to be capable of absorbing the light. The front transmittance x and the diffuse reflectance y of the optical functional layer satisfy a predetermined relationship.

### BACKGROUND OF THE INVENTION

1. Field of the Invention

The present invention relates to an optical sheet providing an observer with a higher quality image by suitably transmitting and absorbing image light or external light, and a display device including the optical sheet.

2. Description of the Related Art

In a display device such as a plasma television using a plasma display panel (hereinafter also referred to as “PDP”), an optical sheet is disposed on an observer side relative to the PDP. The optical sheet has a function of providing the observer with a higher quality image.

With regard to the quality of an image, there are various factors such as front luminance and contrast. The front luminance means brightness of image light emitted in a front direction from a screen. If the front luminance is low, the observer gets an impression that the screen is dark and thus it is difficult to say that the quality of the image light is good. Therefore, it is necessary to secure front luminance equal to or higher than a predetermined level. Meanwhile, the contrast means the ratio in brightness between a bright portion and a dark portion in an image. In the case where the contrast is high, the contour of an object or the like is clearly displayed, so that a sharp image is obtained. On the other hand, in the case where the contrast is low, the brightness of the image tends to be the same over the entire area, so that the image is not sharp. Therefore, in view of obtaining good quality image light, it is also necessary to secure contrast equal to or higher than a predetermined level.

In the related art, in order to improve the contrast, a neutral density (ND) filter layer, a tint filter layer, a neon-light absorbing layer, or a toning filter layer is included as one layer of an optical sheet. All of the ND filter layer, the tint filter layer, the neon-light absorbing layer, and the toning filter layer are layers having a property capable of reducing the amount of light. Among them, the neutral density (ND) filter layer is a layer capable of reducing the amount of light regardless of a wavelength of light. Meanwhile, the tint filter layer, the neon-light absorbing layer, or the toning filter layer is a layer capable of reducing the amount of light with a wavelength within a predetermined range.

According to the ND filter layer (hereinafter, “the ND filter layer” will be described as a representative, but “the tint filter layer”, “the neon-light absorbing layer”, or “the toning filter layer” is also included), external light entering the optical sheet passes through the ND filter layer once, is then reflected at a portion of a display device, and finally passes through the ND filter layer one more time to be emitted to an observer side. Therefore, a large amount of the external light is absorbed, thereby capable of improving the contrast. Meanwhile, image light passes through the ND filter layer only once when the image light is emitted from an image source to the observer side. Therefore, it is possible to secure a significant improvement in contrast as compared with a reduction in the luminance of the image light and possible to secure front luminance and contrast to some extent by providing the ND filter layer.

However, in order to obtain high contrast, it is necessary to use an ND filter layer with low transmittance and thus a reduction in the luminance of image light is large. Then, in order to enhance the luminance of the image light, it is necessary to adopt a technique of increasing the output of the image source itself to increase brightness, but this technique leads to an increase in power consumption.

Also, Patent document 1 (Japanese Patent Application Laid-Open (JP-A) No. 2006-189867) discloses an optical sheet capable of improving luminance and contrast. According to this, there is disclosed a configuration of an external-light blocking layers which comprises: a transparent resin formed on one surface of a filter base and a plurality of wedge-shaped portions disposed in the transparent resin.

However, there is no guarantee that even the optical sheet disclosed in the Patent document 1 is improved in contrast and luminance by an ND filter layer.

### SUMMARY OF THE INVENTION

In consideration of the problem, an object of the present invention is to provide an optical sheet which is capable of improving contrast and front luminance together as compared to a case of using an ND filter layer. Another object of the present invention is to provide a display device including the optical sheet.

Hereinafter, the present invention will be described. For ease of understanding the invention, the reference numerals of the attached drawings are quoted in parenthesis. However, the invention is not limited by the embodiments shown in the drawings.

The first aspect of the present invention is an optical sheet (10) including: a plurality of layers disposed on an observer side relative to an image source (2) and capable of controlling light from the image source and transmitting the light to the observer side, at least one layer of the plurality of layers being an optical functional layer which includes: light transmissive portions (13, 13, . . . ) having a trapezoidal cross section and arranged in parallel along a sheet face to be capable of transmitting the light; and light absorbing portions (14, 14, . . . ) having a wedge-shaped cross section and arranged in parallel between the light transmissive portions to be capable of absorbing the light, and

a front transmittance x and a diffuse reflectance y of the optical functional layer (12) satisfying the expression:

y<0.0026·x^{2.257}.

Here, the front transmittance represents relative luminance of a target sheet in the front direction with respect to a reference sheet in the case where the transmittance of the reference sheet is defined as 100%; it can be obtained, for example, as follows. FIG. 3A is the explanatory view. That is, as shown on the left of FIG. 3A, parallel light source that is parallel to the normal direction of a diffusion plate (the reference sheet) is irradiated and the luminance of the emitted light is measured at each angle (for example, at 1° intervals) within a range of −80° to +80° by a detector. Next, as shown on the right of FIG. 3A, an optical sheet which is an evaluation target is stacked on the diffusion plate and irradiation of light and detection of emitted light are similarly performed. Then, the luminance in the front direction of the emitted light when the evaluation target optical sheet is stacked, in relation to the luminance of the emitted light when there is only the diffusion plate, is expressed as a percentage and this is referred to as the front transmittance.

Meanwhile, diffuse reflectance is defined by all-directional diffuse reflectance obtained by excluding a 45° specular reflection light component from the total luminous reflectance. The diffuse reflectance can be obtained, for example, as follows. FIG. 3B is the explanatory view. A standard white board made of barium sulfate is disposed on the rear face side of an optical sheet to be a target and irradiation light inclined at an angle of 45° with respect to the normal line of the optical sheet is irradiated. At this time, all-directional light except for 45° specular reflection light in an integrating sphere is obtained by a detector. Then, the ratio between the all-directional light except for the specular reflection light and the irradiation light can be calculated and expressed in percentage.

The second aspect of the present invention according to the first aspect of the invention is characterized in that an oblique side of the trapezoidal cross section of the light transmissive portions is inclined at an angle of 1° to 13° with respect to a normal direction of an output plane of the sheet.

The third aspect of the present invention according to the first or second aspect of the invention is characterized in that a diagonal line of the trapezoidal shape of the trapezoidal cross section of the light transmissive portions forms at an angle of 15° to 65° with respect to a normal direction of an output plane of the sheet.

The fourth aspect of the present invention according to any one of the first to third aspects of the invention is characterized in that a ratio of a length of an upper base of the trapezoidal cross section of the light transmissive portions to a pitch of the light transmissive portions is 0.3 to 0.9.

The fifth aspect of the present invention according to any one of the first to fourth aspects of the invention is characterized in that a transmittance of the light absorbing portions is 30% to 70% when the light absorbing portion is produced in a form of layer with a thickness of 6 μm made of only a material of the light absorbing portions.

The sixth aspect of the present invention according to any one of the first to fifth aspects of the invention, further includes at least one layer of a near-infrared absorbing layer, a neon-light absorbing layer, an ultraviolet absorbing layer, and a toning layer.

The seventh aspect of the present invention is a display device including the optical sheet according to any one of the first to sixth aspects of the invention.

According to the present invention, it is possible to provide an optical sheet which is capable of improving contrast while obtaining higher front luminance as compared to the case of using an ND filter, and a display device including the optical sheet.

### BRIEF DESCRIPTION OF THE DRAWINGS

FIG. 1 is a cross-sectional view schematically illustrating a layer structure of an optical sheet according to an embodiment;

FIG. 2 is an enlarged view illustrating a portion of the optical sheet shown in FIG. 1;

FIG. 3A is a view explaining a method of measuring front transmittance;

FIG. 3B is a view explaining a method of measuring diffuse reflectance;

FIG. 4 is an enlarged view illustrating a portion of an optical sheet in an example in which the cross section of a light absorbing unit is trapezoidal;

FIG. 5 is a view illustrating a portion of a plasma television with an optical sheet where a PDP and the optical sheet are disposed; and

FIG. 6 is a graph illustrating results of examples.

### DESCRIPTION OF MODES FOR CARRYING OUT THE INVENTION

The aforementioned functions and benefits of the present invention will be apparent from the following best modes for carrying out the present invention. Hereinafter, the present invention will be described on the basis of embodiments shown in the drawings. However, the present invention is not limited to the embodiments.

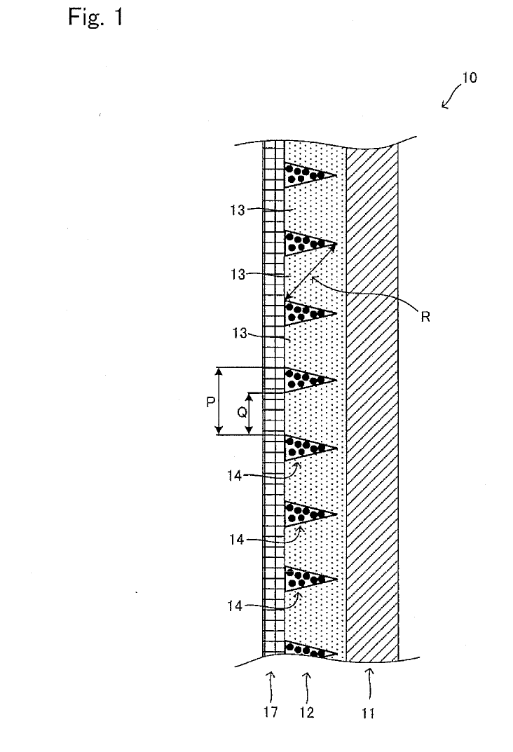

FIG. 1 is a cross-sectional view schematically illustrating a layer structure of an optical sheet 10 according to the first embodiment. In FIG. 1, for ease of viewing, repeated reference numerals may be partially omitted (which is the same in each drawing shown below). The optical sheet 10 is configured to include: a PET film layer 11 serving as a base material layer; an optical functional layer 12; and an adhesive layer 17. The individual layers extend in the front and rear directions of the plane of paper while maintaining the cross section shown in FIG. 1. The individual layers will be described below.

The PET film layer 11 is a film layer serving as a base material layer for forming the optical functional layer 12 on one surface of the PET film layer 11 and is formed by using polyethylene terephthalate (PET) as a main component. The PET film layer 11 may contain other resins as long as the PET film layer contains PET as the main component. Here, the main component means a component contained in an amount of not less than 50 mass % based on the weight of the entire PET film layer. The PET film layer 11 may further contain various additives. Examples of general additives may include an antioxidant such as a phenol type antioxidant and a stabilizer such as a lactone type stabilizer.

Although the PET film layer has been described here as the base material layer, the base material layer is not necessarily made of PET but may be made of “a polyester-based resin” such as polybutylene terephthalate (PBT) resin or polytrimethylene terephthalate (PTT) resin. In the present embodiment, in terms of performance, mass productivity, cost, availability, and so on, a resin containing polyethylene terephthalate (PET) as the main component has been described as a preferable material.

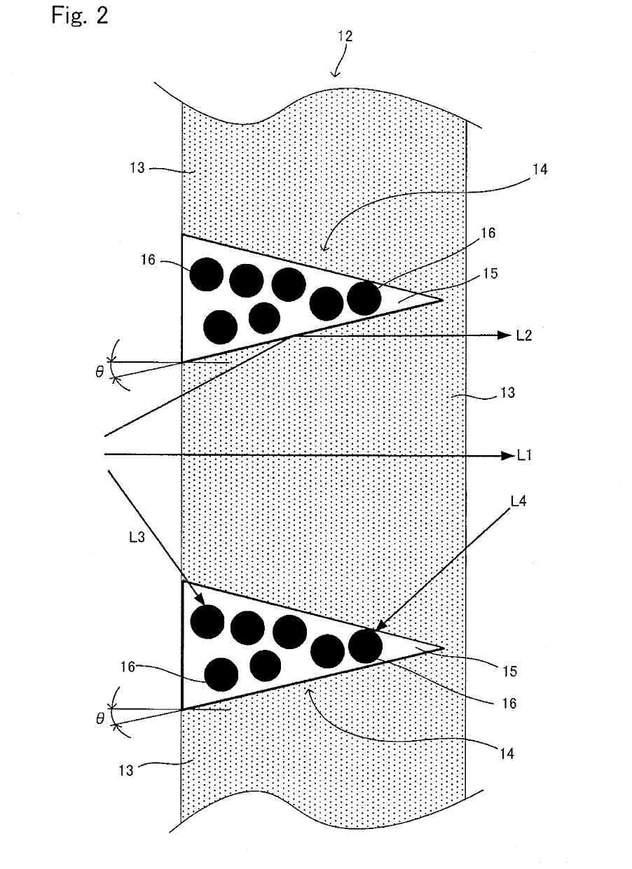

The optical functional layer 12 includes: light transmissive portions 13, 13, . . . having an approximate trapezoidal cross section shape in a cross section perpendicular to the sheet face of the optical sheet 10; and light absorbing portions 14, 14, . . . disposed between the light transmissive portions 13, 13, . . . FIG. 2 shows an enlarged view focusing on two light absorbing portions 14, 14 and light transmissive portions 13, 13, 13 adjacent thereto. The optical functional layer 12 will be described with reference to FIG. 1, FIG. 2, and other suitable drawings.

The light transmissive portions 13, 13, . . . are elements having an approximate trapezoidal cross section shape in which an upper base is disposed on one sheet face side and a lower base is disposed on the other sheet face side. Further, the light transmissive portions 13, 13, . . . is made of a light transmissive resin with a refractive index of Nₚ. This is usually formed of, for example, epoxy acrylate characterized by being cured by ionizing radiation, ultraviolet, and so on. The magnitude of Nₚ is not limited especially; however, in terms of availability of material, the magnitude is preferably 1.45 to 1.60. The light transmissive portions 13, 13, . . . transmits image light, whereby the image light is provided to an observer.

The light absorbing portions 14, 14, . . . are portions disposed between the light transmissive portions 13, 13, . . . Thus, the light absorbing portions 14, 14, . . . have a substantially triangular wedge shape whose base corresponds to the upper base side of the light transmissive portions 13, 13, . . . , and apex facing the base corresponds to the lower base side of the light transmissive portions 13, 13, . . . The light absorbing portions 14, 14, . . . include a binder portions 15 filled with a material with a refractive index of N_{b} and light absorbing particles 16, 16, . . . mixed in the binder portions 15. External light enters and is absorbed by the light absorbing portions 14, 14, . . . , whereby the contrast of an image can be improved.

A binder material filled in the binder portions 15 is formed of a material with a refractive index of N_{b}. The magnitude of the refractive index N_{b} is not specifically limited; however, in terms of availability of material, the magnitude is preferably 1.50 to 1.60. Although the difference between the refractive indexes Nₚ and N_{b} is not specifically limited, in the case where the binder material is formed of the material with the refractive index N_{b} having a magnitude equal to or less than the refractive index Nₚ of the light transmissive portions 13, 13, . . . , the difference is preferably more than 0 and 0.06 or less. This can improve the transmittance without reducing the contrast. More preferably, the difference is 0.01 or less, and further preferably, the difference is 0.005 or less. Meanwhile, in the case where the binder material is formed of the material with the refractive index N_{b} having a magnitude larger than the refractive index Nₚ of the light transmissive portions 13, 13, . . . , the difference in the refractive index is 0.01 or less, and more preferably, 0.005 or less. This can improve the external-light absorption effect and further improve the contrast without significantly reducing the transmittance. Although a material used as the binder material is not specifically limited, urethane acrylate characterized by being cured by ionizing radiation, ultraviolet, and so on can be used, for example.

According to the relationship between the condition of the refractive-index difference and the incident angle of image light, a part of the image light can be reflected at the interfaces of the light absorbing portions 14, 14, . . . without entering the light absorbing portions 14, 14, . . . , and is provided to an observer; thereby capable of providing a bright image.

The average diameter of the light absorbing particles 16, 16, . . . is preferably not less than 1 μm in terms of availability and handling. The light absorbing particles 16, 16, . . . are colored to a predetermined density by a pigment such as carbon or a dye such as a red, blue, or yellow dye. The light absorbing particles 16, 16, . . . may be commercially available colored resin fine particles. The refractive index of the light absorbing particles 16, 16, . . . is not particularly limited; however, the refractive index is preferably 1.45 to 1.60.

Here, although the light absorption performance of the light absorbing portions 14, 14, . . . can be suitably adjusted according to the purposes, the light absorbing portions are preferably configured to have such a light absorption performance that the transmittance is 30% to 70% in the measurement of the transmittance of a sheet with a thickness of 6 μm formed only of the material constituting the light absorbing portions. Although the means for attaining the transmittance of 30% to 70% is not specifically limited, for example, the content of light absorbing particles and the like may be adjusted.

Further, an angle θ of the oblique sides (two sides extending in the sheet thickness direction) of the light absorbing portions 14, 14, . . . with respect to the normal line of the sheet surface is preferably 1° to 13°.

The magnitude of each of the portions of the optical sheet 10 shown by reference symbols P and Q in FIG. 1 can be suitably adjusted according to the purposes, and is not specifically limited. A pitch shown by the reference symbol P is preferably within a range of 20 μm to 90 μm. Further, an aperture ratio defined as (Q/P) is preferably within a range of 0.3 to 0.9.

Also, an aperture angle, which is an angle formed by a diagonal line of any one of the light transmissive portions 13, 13, . . . shown by a reference symbol R in FIG. 1 (a line connecting an apex of a light absorbing portion and an end portion of a base of the adjacent light absorbing portion) and the normal line of the sheet surface, is preferably 15° to 65°. More preferably, the aperture angle is 15° to 30°.

The optical functional layer 12 further has the following characteristics. That is, the optical functional layer 12 meets The formula (1) when the front transmittance is x and the diffuse reflectance is y.

[Formula 1]

y<0.0026·x^{2.257} (1)

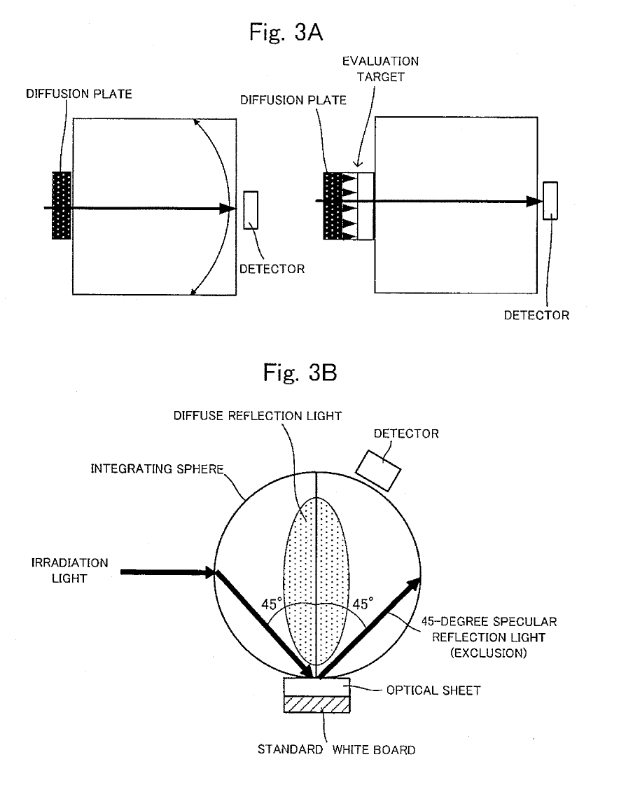

Here, the front transmittance is evaluated in accordance with the method as shown in FIG. 3A. That is, as shown on the left of FIG. 3A, parallel light is irradiated in the direction parallel to the normal direction of a diffusion plate (the reference sheet) and the luminance of the emitted light is measured at each angle (for example, at 1° intervals) within a range of −80° to +80° by a detector. Next, as shown on the right of FIG. 3A, an optical sheet as an evaluation target is stacked on the diffusion plate and irradiation of light and detection of emitted light are similarly performed. Then, the luminance in the front direction of the emitted light when the evaluation target optical sheet is stacked, in relation to the luminance of the emitted light when there is only the diffusion plate, is expressed as a percentage and this is referred to as the front transmittance.

Meanwhile, diffuse reflectance is defined by all-directional diffuse reflectance obtained by excluding a 45° specular reflection light component from the total luminous reflectance. FIG. 3B shows a view explaining a method of measuring diffuse reflectance. A standard white board made of barium sulfate is disposed on the rear face side of an optical sheet as a target and irradiation light inclined at an angle of 45° with respect to the normal line of the optical sheet is irradiated. At this time, all-directional light except for 45° specular reflection light in an integrating sphere is obtained by a detector. Then, the ratio between the all-directional light except for the specular reflection light and the irradiation light can be calculated and expressed in percentage.

The front transmittance and the diffuse reflectance defined as described above satisfy the formula (1), thereby capable of improving contrast and front luminance together, as compared to a case of using an ND filter layer.

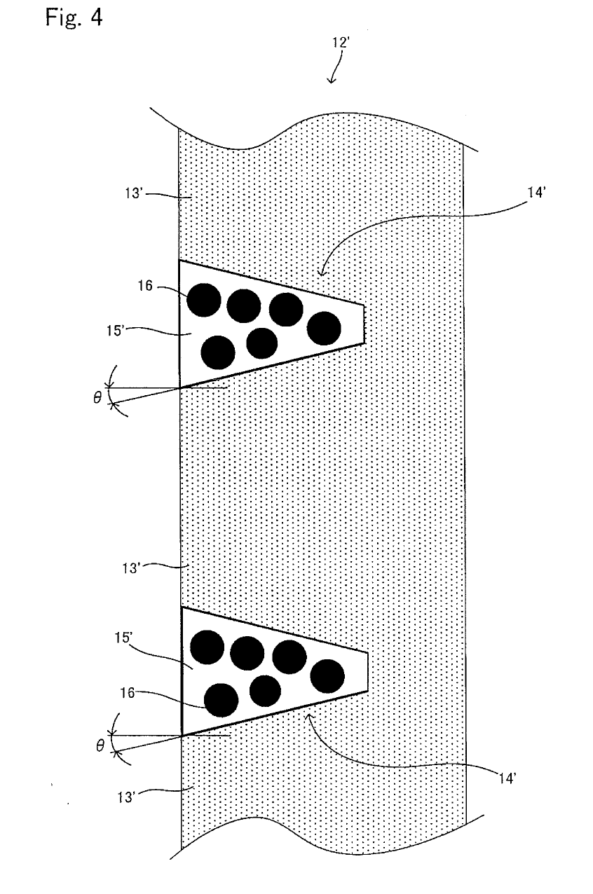

In the present embodiment, the case where the light absorbing portions has a triangular cross section shape has been described. However, the cross section shape of the light absorbing portions is not limited thereto but may be a trapezoidal shape. FIG. 4 shows light absorbing portions 14′, 14′ and light transmissive portions 13′, 13′, 13′ adjacent thereto, of an optical functional layer 12′ in an example in which the cross section of the light absorbing portions is trapezoidal. In this configuration, as shown in FIG. 4, the cross section of the light absorbing portions 14′ is trapezoidal. In this case, the long base (lower base) of the trapezoidal shape can be disposed on the opposite side (the left side of the plane of paper) to the PET film layer (not shown) and the short base can be disposed on the PET film layer side (the right side of the plane of paper).

Returning to FIG. 1, another configuration of the optical sheet 10 will be described. The adhesive layer 17, as described later, is a layer disposed with an adhesive for bonding the optical sheet 10 to other sheets or members disposed in a plasma television 1, for example. An adhesive used in the adhesive layer 17 transmits light therethrough; as long as the adhesive can suitably bond the optical sheet 10 to other components, the material is not particularly limited. For example, acrylic-type copolymer can be used, and the viscosity is, for example, approximately several N/25 mm to 20N/25 mm.

The optical sheet 10 is produced as follows, for example. A liquid body which is a material of light transmissive portions is applied to one surface side of the PET film layer 11. Then, while the material of the light transmissive portions is held between a roll die for forming the shape of the light transmissive portions and a PET film, ultraviolet is irradiated to cure the material, to form the light transmissive portions 13, 13, . . . . Then, a liquid body, which contain a transparent resin to be a material of binder portions and black light absorbing particles, is filled in between the light transmissive portions 13, 13, . . . , the liquid body. Extra material is then removed from the liquid body by, for example, strickling. Ultraviolet is then irradiated to cure the liquid body, and, thus, to form the light absorbing portions 14, 14, . . . . As a result, the optical functional layer 12 is produced. The adhesive layer 17 is stacked on the produced optical functional layer 12.

On the optical sheet 10, a layer having other functions may be further stacked. For example, an antireflection (AR) layer, an antiglare (AG) layer, a neon line absorbing layer, a toning layer, an ultraviolet absorbing layer, a near-infrared absorbing layer, a hard coating layer, an antifouling layer, or the like may be further stacked.

The antireflection (AR) layer is a layer having a so-called anti-reflection function by preventing reflection of light. The antireflection layer is generally configured with a multi-layer in which low-refractive-index layers and high-refractive-index layer are alternately stacked.

The antiglare (AG) layer is a layer having a function of suppressing glare on a screen. This layer fulfils the function by diffusely reflecting light. Therefore, the antiglare layer can be a layer made of a resin binder in which inorganic filers such as silica are contained or a layer with a surface having fine recesses and protrusions.

The neon line absorbing layer is a layer having a function of absorbing a neon line emitted from an image source. Since the light emission spectrum band of the neon line is a wavelength range of 550 nm to 640 nm, in this band, it is preferable that the spectral transmittance of the neon line is small. To this end, for example, a suitable pigment may be dispersed in a binder resin.

The toning layer is a layer for adjusting a color to improve color impurity of light emitted from a panel, a color reproduction range, a display color during power off, etc. For example, the toning layer may be made of a composition obtained by dispersing a toning pigment in a binder resin or may be formed by applying the composition to a transparent base member or another functional filter, and performing a dry process, a curing process, etc., if necessary. The toning pigment may be an arbitrary combination of well-known pigments having maximum absorption wavelengths within a visible range of 380 nm to 780 nm according to the purposes. The toning pigment may be a well-known pigment.

The optical functional layer 12 is effective in absorbing external light forming a large angle with respect to the normal line of the sheet face but is less effective in absorbing external light forming a small angle with respect to the normal line. Therefore, it is preferable that the optical sheet should have a layer for absorbing neon light or a layer combined with a toning layer; whereby the external light with a small angle with respect to the normal line of the sheet face can also be absorbed and the bright room contrast can be improved in any environment.

The ultraviolet absorbing layer is a layer having a function of absorbing ultraviolet to prevent another member from being deteriorated by the ultraviolet. To this end, for example, the ultraviolet absorbing layer may be formed by dispersing an ultraviolet absorbing material in a binder resin.

The near-infrared absorbing layer is a layer having a function of absorbing near infrared ray. Since the wavelength of the near infrared ray is within a range of 800 nm to 1100 nm, it is preferable that the near-infrared absorbing layer should have a small near-infrared transmittance in the range. In order to form the near-infrared absorbing layer, for example, a suitable pigment may be dispersed in a binder resin.

The hard coating layer is a layer that functions as a protective layer. So, the hard coating layer needs to have some degree of strength. The hard coating layer may be formed as a coating film using, for example, an ionizing radiation curable resin, which is selected from: multi-functional (meth)acrylate prepolymers such as polyester(meth)acrylate, urethane(meth)acrylate and epoxy(meth)acrylate; or multi-functional, for example, three- or higher-functional (meth)acrylate monomers such as trimethylol propane tri(meth)acrylate, pentaerythritol tetra(meth)acrylate and dipentaerythritol hexa(meth)acrylate. These may be used alone, or in combination of two or more kinds as blended.

The antifouling layer is a layer functioning as a protective layer like the hard coating layer. In general, the antifouling layer is formed by coating a material having a water-repellent property and an oil-repellent property.

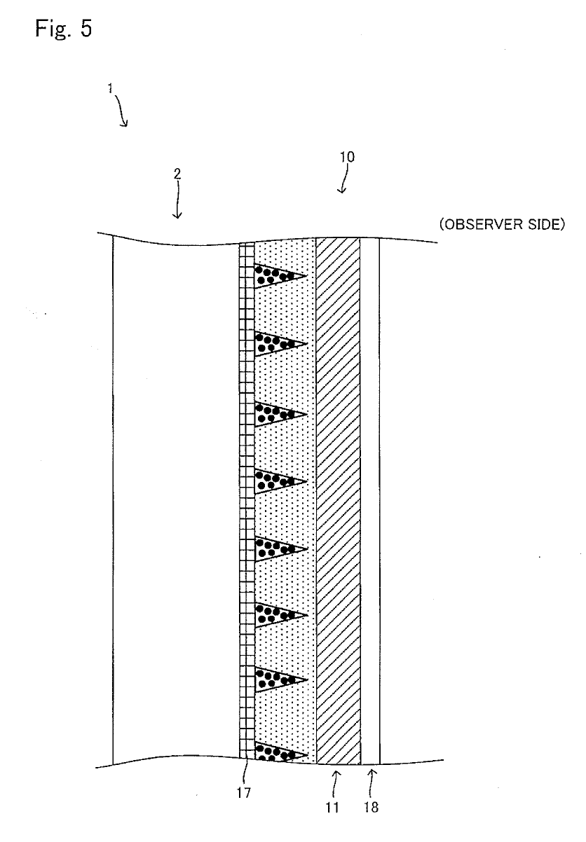

Next, a configuration of a plasma television 1 which is a display device and is provided with the optical sheet 10 as described above will be described. FIG. 5 is a schematic view explaining a plasma television 1 which includes a plasma panel 2 (hereinafter also referred to as “PDP 2”) and an optical sheet 10 disposed on the emission side of the PDP 2. FIG. 5 shows a cross section focusing on a portion where the PDP 2 and the optical sheet 10 are disposed, and the right of the plane of paper is the observer side.

As shown in FIG. 5, in the present embodiment, the optical sheet 10 is bonded directly to the PDP 2 which is an image source by the adhesive layer 17. Also, here, the AR layer 18 is disposed on the observer side of the PET film layer 11.

In the present embodiment, an example in which the optical sheet 10 is bonded directly to the PDP 2 has been described. However, the present invention is not limited thereto. The optical sheet 10 may be bonded to a glass plate by the adhesive layer 17 and the optical sheet 10 with the glass plate may be disposed with a predetermined interval from the PDP 2.

Next, how the optical sheet 10 transmits image light or blocks external light will be described. FIG. 2 shows an example of a light path. If the display device operates, as shown in FIG. 2, image light L1 passes through a light transmissive portion 13 and is emitted to the observer side. Also, image light L2 enters the interface of the light transmissive portion 13 and a light absorbing portion 14 at an angle smaller than a critical angle based on the refractive-index difference between the light transmissive portion 13 and the light absorbing portion 14; thus, it is totally reflected at the interface so as to be emitted to the observer side. At this time, since the oblique side of the light absorbing portion 14 is inclined as described above, the angle of the light varies before and after reflection at the oblique side.

Image light L3 enters the interface of a light transmissive portion 13 and a light absorbing portion 14 at an angle larger than the critical angle based on the refractive-index difference between the light transmissive portion 13 and the light absorbing portion 14. Therefore, the image light L3 progresses to the light absorbing portion 14 without being reflected at the interface and is absorbed by the light absorbing particles 16. Meanwhile, similar to the image light L3, external light L4 penetrates into a light absorbing portion 14 and is absorbed by the light absorbing particles 16. As described above, since a part of the external light or stray light is absorbed by the optical absorbing particles, the contrast can be improved. In addition, since a part of the image light is reflected at the interface of the light transmissive portion and the light absorbing portion and is provided to the observer, such a part of the image light can contribute to improvement of luminance.

In the present embodiment, the optical sheet 10 is disposed such that the upper base side of the light transmissive portion 13 (the base side of the light absorbing portion 14) of the optical functional layer 12 faces the PDP 2 side. However, the upper base side of the light transmissive portion 13 may face the observer side. In this case, the reflection angle of image light reflected at the interface of the light transmissive portion 13 and the light absorbing portion 14 is different from that in the aforementioned display device. However, similarly, the relationship between the front transmittance and the diffuse reflectance meets the formula (1). Therefore, it is possible to improve the contrast and front luminance.

The optical sheet having the aforementioned configuration will be described in more detail in relation to the following examples. However, the present invention is not limited to the scope of the examples.

### EXAMPLES

The front transmittance and the diffuse reflectance were measured by changing the configuration of the light transmissive portions and the light absorbing portions of the optical functional layer as examples. In the examples, the front transmittance and the diffuse reflectance of optical functional layers which are examples and comparative examples and ND filter layers which are reference examples and become the basis of the formula (1) were measured. Here, the measurement of the front transmittance and the diffuse reflectance was carried out as follows.

<Measurement of Front Transmittance>

The front transmittance was measured on the basis of a configuration shown in FIG. 3A. The details are as follows. The measurement of the front transmittance was made by a goniophotometer (GP-500 manufactured by Murakami Color Research Laboratory Co., Ltd.). A halogen lamp was used as a light source, and diffusion plates having characteristics of peak gains at 0.68, αv68.5°, βv75.1°, and γv79.1° were used. Here, the peak gain means the largest numerical value of luminance ratios which are obtained by measuring the luminance value of transmitted light irradiated onto a perfect diffusion transmission face by a luminance meter, measuring luminance values of light irradiated from each angle onto an optical sheet under the same condition, and calculating the ratios of the luminance values when the luminance value of the transmission light is defined as 1. Also, the perfect diffusion means that the angle characteristic of radiation from a diffusion face obeys Lambert's cosine law and the diffusion face is an ideal face having the same radiance factor or luminance L in all directions. αv is an average value of plus and minus angles at which the gain is ½ of the peak gain, βv is an average value of plus and minus angles at which the gain is ⅓ of the peak gain, and γv is an average value of plus and minus angles at which the gain is 1/10 of the peak gain. The front transmittance was defined as a ratio between the cases when a differ plate and an optical sheet are disposed on the light source side and when only a diffusion plate is disposed.

<Measurement of Diffuse Reflectance>

The diffuse reflectance was measured on the basis of a configuration shown in FIG. 3B. Details are as follows. The measurement of the diffuse reflectance was made by a haze meter (HR-100 manufactured by Murakami Color Research Laboratory Co., Ltd.). D65 was used as a light source, and a standard white board was made of barium sulfate and had a total luminous reflectance of 98.4%. An optical sheet was disposed such that irradiation light corresponded to the external light entrance side and the standard white board corresponded to the image light side, and then the diffuse reflectance was measured.

The conditions and results of the measurements are shown in Table 1 and Table 2. Here, the contrast is a value obtained by dividing the front transmittance by the diffuse reflectance. Here, an CD value is a transmittance of the light absorbing portion, which represents an optical density in the case of a thickness of 60 μm. Also, mounted absorptive ND filters manufactured by SIGMA KOKI Co., LTD. were used as the ND filters described in the reference examples. For measurement, No. 22 did use no ND filter, No. 23 used a model No. AND-50S-70 ND filter, No. 24 used a model No. AND-50S-50 ND filter, and No. 25 used a combination of a model No. AND-50S-70 ND filter and a model No. AND-50S-50 ND filter. The symbol φ represents an angle which a diagonal line of a trapezoidal shape of a trapezoidal cross section of a light transmissive portion forms with respect to the normal direction of the emission surface of the sheet.

TABLE 1

| | | | | Shape of light absorbing portion | | | | | Refractive | Refractive | Direction | | |
|---|---|---|---|---|---|---|---|---|---|---|---|---|---|
| | | | | Width | Width of | | | | index of | index of | of front | | |
| | | | Aperture | of | front | Angle of | | | light | light | end of light | | |
| | | Pitch | ratio | base | end | oblique | Depth | φ | transmissive | absorbing | absorbing | OD | |
| No | Layer | (μm) | (%) | (μm) | (μm) | side (°) | (μm) | (°) | portion | portion | portion | value | Notes |
| 1 | Optical | 85.0 | 80 | 17.0 | 4.0 | 3.0 | 120.2 | 32.5 | 1.550 | 1.547 | Observer | 2.0 | Example |
| | functional | | | | | | | | | | side | | |
| | layer | | | | | | | | | | | | |
| 2 | Optical | 85.0 | 90 | 8.5 | 4.0 | 1.0 | 119.8 | 34.0 | 1.550 | 1.547 | Observer | 2.0 | Example |
| | functional | | | | | | | | | | side | | |
| | layer | | | | | | | | | | | | |
| 3 | Optical | 85.0 | 70 | 25.5 | 4.0 | 5.0 | 120.6 | 30.9 | 1.550 | 1.547 | Observer | 2.0 | Example |
| | functional | | | | | | | | | | side | | |
| | layer | | | | | | | | | | | | |
| 4 | Optical | 85.0 | 50 | 42.5 | 4.0 | 9.0 | 120.3 | 27.9 | 1.550 | 1.547 | Observer | 2.0 | Example |
| | functional | | | | | | | | | | side | | |
| | layer | | | | | | | | | | | | |
| 5 | Optical | 85.0 | 30 | 59.5 | 4.0 | 13.0 | 119.3 | 24.9 | 1.550 | 1.547 | Observer | 2.0 | Example |
| | functional | | | | | | | | | | side | | |
| | layer | | | | | | | | | | | | |
| 6 | Optical | 85.0 | 80 | 17.0 | 4.0 | 3.6 | 100.1 | 37.4 | 1.550 | 1.547 | Observer | 2.0 | Example |
| | functional | | | | | | | | | | side | | |
| | layer | | | | | | | | | | | | |
| 7 | Optical | 85.0 | 80 | 17.0 | 4.0 | 4.5 | 80.0 | 43.7 | 1.550 | 1.547 | Observer | 2.0 | Example |
| | functional | | | | | | | | | | side | | |
| | layer | | | | | | | | | | | | |
| 8 | Optical | 85.0 | 80 | 17.0 | 4.0 | 6.0 | 59.9 | 52.0 | 1.550 | 1.547 | Observer | 2.0 | Example |
| | functional | | | | | | | | | | side | | |
| | layer | | | | | | | | | | | | |
| 9 | Optical | 85.0 | 80 | 17.0 | 4.0 | 9.0 | 39.8 | 62.5 | 1.550 | 1.547 | Observer | 2.0 | Example |
| | functional | | | | | | | | | | side | | |
| | layer | | | | | | | | | | | | |
| 10 | Optical | 71.0 | 69 | 22.0 | 4.0 | 5.0 | 108.0 | 29.1 | 1.550 | 1.547 | Observer | 2.0 | Example |
| | functional | | | | | | | | | | side | | |
| | layer | | | | | | | | | | | | |
| 11 | Optical | 71.0 | 69 | 22.0 | 4.0 | 5.0 | 108.0 | 29.1 | 1.550 | 1.547 | Light | 2.0 | Example |
| | functional | | | | | | | | | | source | | |
| | layer | | | | | | | | | | side | | |
| 12 | Optical | 71.0 | 69 | 22.0 | 4.0 | 5.0 | 108.0 | 29.1 | 1.550 | 1.490 | Observer | 2.0 | Example |
| | functional | | | | | | | | | | side | | |
| | layer | | | | | | | | | | | | |
| 13 | Optical | 71.0 | 69 | 22.0 | 4.0 | 5.0 | 108.0 | 29.1 | 1.550 | 1.490 | Light | 2.0 | Example |
| | functional | | | | | | | | | | source | | |
| | layer | | | | | | | | | | side | | |
| 14 | Optical | 60.0 | 50 | 30.0 | 3.0 | 10.0 | 110.0 | 22.3 | 1.580 | 1.490 | Observer | 2.0 | Example |
| | functional | | | | | | | | | | side | | |
| | layer | | | | | | | | | | | | |
| 15 | Optical | 60.0 | 50 | 30.0 | 3.0 | 10.0 | 110.0 | 22.3 | 1.580 | 1.490 | Light | 2.0 | Comparative |
| | functional | | | | | | | | | | source | | example |
| | layer | | | | | | | | | | side | | |
| 16 | Optical | 85.0 | 80 | 17.0 | 4.0 | 18.0 | 19.4 | 75.8 | 1.550 | 1.547 | Observer | 2.0 | Example |
| | functional | | | | | | | | | | side | | |
| | layer | | | | | | | | | | | | |
| 17 | Optical | 85.0 | 50 | 42.5 | 4.0 | 43.0 | 20.4 | 72.3 | 1.550 | 1.547 | Observer | 2.0 | Comparative |
| | functional | | | | | | | | | | side | | example |
| | layer | | | | | | | | | | | | |
| 18 | Optical | 85.0 | 30 | 59.5 | 4.0 | 54.0 | 20.0 | 70.1 | 1.550 | 1.547 | Observer | 2.0 | Example |
| | functional | | | | | | | | | | side | | |
| | layer | | | | | | | | | | | | |
| 19 | Optical | 85.0 | 80 | 17.0 | 4.0 | 32.0 | 10.1 | 82.5 | 1.550 | 1.547 | Observer | 2.0 | Comparative |
| | functional | | | | | | | | | | side | | example |
| | layer | | | | | | | | | | | | |
| 20 | Optical | 85.0 | 50 | 42.5 | 4.0 | 62.0 | 10.1 | 81.0 | 1.550 | 1.547 | Observer | 2.0 | Comparative |
| | functional | | | | | | | | | | side | | example |
| | layer | | | | | | | | | | | | |
| 21 | Optical | 85.0 | 30 | 59.5 | 4.0 | 70.0 | 10.0 | 79.8 | 1.550 | 1.547 | Observer | 2.0 | Comparative |
| | functional | | | | | | | | | | side | | example |
| | layer | | | | | | | | | | | | |
| 22 | — | | | | | | | | | | | | Reference |
| | | | | | | | | | | | | | example |
| 23 | ND filter | | | | | | | | | | | | Reference |
| | | | | | | | | | | | | | example |
| 24 | ND filter | | | | | | | | | | | | Reference |
| | | | | | | | | | | | | | example |
| 25 | ND filter | | | | | | | | | | | | Reference |
| | | | | | | | | | | | | | example |

TABLE 2

| | | | Value of | | |
|---|---|---|---|---|---|
| | Front | Diffuse | right side | | |
| | transmittance | reflectance | of Formula | | |
| No | x(%) | y(%) | (1) | Contrast | Notes |
| 1 | 68.7 | 18.5 | 36.4 | 3.71 | Example |
| 2 | 80.1 | 26.2 | 51.5 | 3.06 | Example |
| 3 | 60.4 | 8.9 | 27.3 | 6.79 | Example |
| 4 | 42.6 | 3.5 | 12.3 | 12.17 | Example |
| 5 | 22.9 | 1.6 | 3.0 | 14.31 | Example |
| 6 | 71.1 | 27.5 | 39.3 | 2.59 | Example |
| 7 | 71.7 | 33.4 | 40.1 | 2.15 | Example |
| 8 | 72.2 | 36.9 | 40.7 | 1.96 | Example |
| 9 | 74.6 | 41.6 | 43.8 | 1.79 | Example |
| 10 | 63.9 | 14.1 | 30.9 | 4.53 | Example |
| 11 | 62.0 | 14.9 | 28.9 | 4.16 | Example |
| 12 | 74.5 | 13.4 | 43.7 | 5.56 | Example |
| 13 | 57.7 | 16.9 | 24.6 | 3.41 | Example |
| 14 | 70.9 | 5.6 | 39.1 | 12.66 | Example |
| 15 | 48.8 | 27.5 | 16.8 | 1.77 | Comparative |
| | | | | | example |
| 16 | 79.1 | 49.2 | 50.0 | 1.61 | Example |
| 17 | 63.1 | 31.6 | 30.0 | 2.00 | Comparative |
| | | | | | example |
| 18 | 52.9 | 19.8 | 20.2 | 2.67 | Example |
| 19 | 83.5 | 62.1 | 56.5 | 1.34 | Comparative |
| | | | | | example |
| 20 | 73.9 | 48.7 | 42.9 | 1.52 | Comparative |
| | | | | | example |
| 21 | 67.4 | 40.0 | 34.9 | 1.69 | Comparative |
| | | | | | example |
| 22 | 100 | 84.9 | 84.9 | 1.18 | Reference |
| | | | | | example |
| 23 | 63.7 | 30.7 | 30.7 | 2.07 | Reference |
| | | | | | example |
| 24 | 45.2 | 14.1 | 14.1 | 3.21 | Reference |
| | | | | | example |
| 25 | 31.5 | 6.2 | 6.2 | 5.08 | Reference |
| | | | | | example |

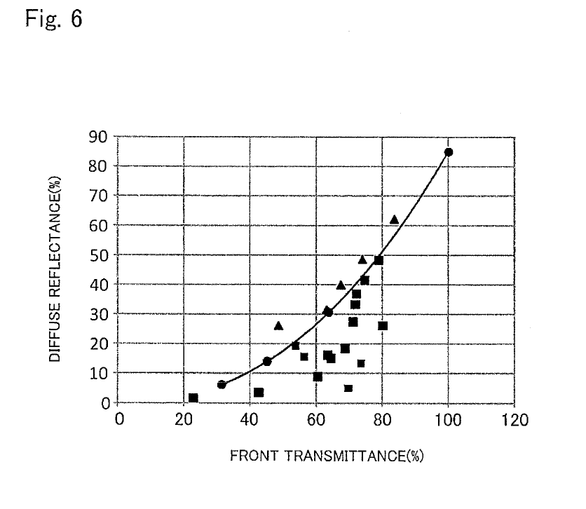

FIG. 6 shows a graph in which the horizontal axis represents the front transmittance and the vertical axis represents the diffuse reflectance. The ND filters which are the reference examples are shown by “”, the examples are shown by “▪”, and the comparative examples are shown by “▴”. As for the ND filters, an approximate curved line is shown as a solid line. The approximate curved line corresponds to the formula (1). In FIG. 6, when the front transmittance increases and the diffuse reflectance decreases, the performance is better. That is, as going to the right lower side of the graph, the performance is more superior.

As can be seen from FIG. 6, all of the examples are located on the right lower side relative to the reference examples using the ND filters and thus are more superior in performance. Meanwhile, it can be seen that the comparative examples are worse in performance than the ND filters.

Also, it can be seen that, among examples meeting the formula (1), No. 16 and No. 18 having a value of φ greater than 65° becomes a value close to the right side of the formula (1) and examples (No. 1 to No. 14) having a value of φ less than 65° are more superior in performance.

The present invention has been described in conjunction with the embodiments considered to be most practical and preferable at the present moment. However, the present invention is not limited to the embodiments disclosed in the specification of the present application but various modifications and variations can be made within limits not contradicting the purport or the idea of the present invention that can be read from the appended claims and the whole contents of the specification. It should be understood that the optical sheets and display devices according to such modifications and variations are also considered to be within the technical scope of the present invention.

1. An optical sheet comprising:
a plurality of layers disposed on an observer side relative to an image source and capable of controlling light from the image source and transmitting the light to the observer side,
at least one layer of the plurality of layers being an optical functional layer which includes: light transmissive portions having a trapezoidal cross section and arranged in parallel along a sheet face to be capable of transmitting the light; and light absorbing portions having a wedge-shaped cross section and arranged in parallel between the light transmissive portions to be capable of absorbing the light, and
a front transmittance x and a diffuse reflectance y of the optical functional layer satisfying the expression:
y<0.0026·x^{2.257}.

2. The optical sheet according to claim 1,
wherein an oblique side of the trapezoidal cross section of the light transmissive portions is inclined at an angle of 1° to 13° with respect to a normal direction of an output plane of the sheet.

3. The optical sheet according to claim 1,
wherein a diagonal line of the trapezoidal shape of the trapezoidal cross section of the light transmissive portions forms at an angle of 15° to 65° with respect to a normal direction of an output plane of the sheet.

4. The optical sheet according to claim 1,
wherein a ratio of a length of an upper base of the trapezoidal cross section of the light transmissive portions to a pitch of the light transmissive portions is 0.3 to 0.9.

5. The optical sheet according to claim 1,
wherein a transmittance of the light absorbing portions is 30% to 70% when the light absorbing portion is produced in a form of layer with a thickness of 6 μm made of only a material of the light absorbing portions.

6. The optical sheet according to claim 1, further comprising:
at least one layer of a near-infrared absorbing layer, a neon-light absorbing layer, an ultraviolet absorbing layer, and a toning layer.

7. A display device comprising the optical sheet according to claim 1.
